(19) United States
(12) Patent Application Publication
(10) Pub. No.: US 2013/0145881 A1
(43) Pub. Date: Jun. 13, 2013

(54) KEY ASSEMBLY

(71) Applicants: ZHEN-LIN LIU, Shenzhen City (CN); WEN-ZE LIU, Shenzhen City (CN)

(72) Inventors: ZHEN-LIN LIU, Shenzhen City (CN); WEN-ZE LIU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/495,672

(22) Filed: Jun. 13, 2012

(30) Foreign Application Priority Data
Dec. 7, 2011 (CN) 201110402779.6

(51) Int. Cl. G05G 1/02

(52) U.S. Cl. 74/470

(57) ABSTRACT

A key assembly includes a key element and an engaging element. The key element has a main body including a number of elastic portions and a number of notches. The notches are defined at one side of the main body. The engaging element includes a number of latch portions protruding from one side of the engaging element. The latch portions mate in the notches. When the key element is operated, the elastic portions deformedly allow the latch portions to move out of or moving in the notches.

### BACKGROUND

1. Technical Field

The present disclosure relates to a key assembly applied to portable electronic device.

2. Description of Related Art

Portable electronic devices, such as mobile-phones and personal digital assistants, typically define key assemblies on panels. The key assembly is attached to the housing of the portable electronic device by welding, hot melting, or by matching positioning posts and limiting holes. However, the assembly process gives the assembled key a low flexibility, and greatly affects the operation of the key assemblies.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an exploded view of an exemplary embodiment of a key assembly.

FIG. 2 is an assembly view of the key assembly shown in FIG. 1.

FIG. 3 is a cross-sectional view of the key assembly taken along line III-III of FIG. 2.

FIG. 4 is a cross-sectional view of the key assembly taken along line IV-IV of FIG. 2.

### DETAILED DESCRIPTION

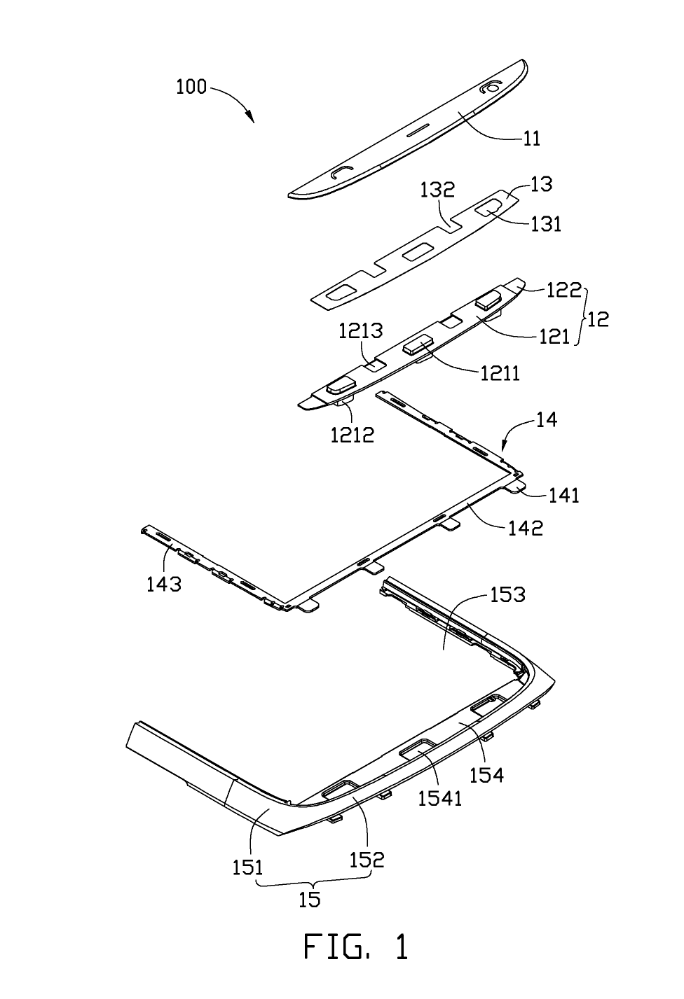

FIG. 1 shows a key assembly 100 according to an exemplary embodiment. The key assembly 100 can be applied to a mobile-phone, or a PDA, for example. The key assembly 100 includes a pressing element 11, a key element 12, a shielding element 13, an engaging element 14, and a base 15.

The pressing element 11 may be part of a touch panel of an electronic device (not shown). A number of indicating symbols are formed on the pressing element 11 for users to operate. The indicating symbols can be a connection symbol, a hang-up symbol, and a guiding symbol, for example.

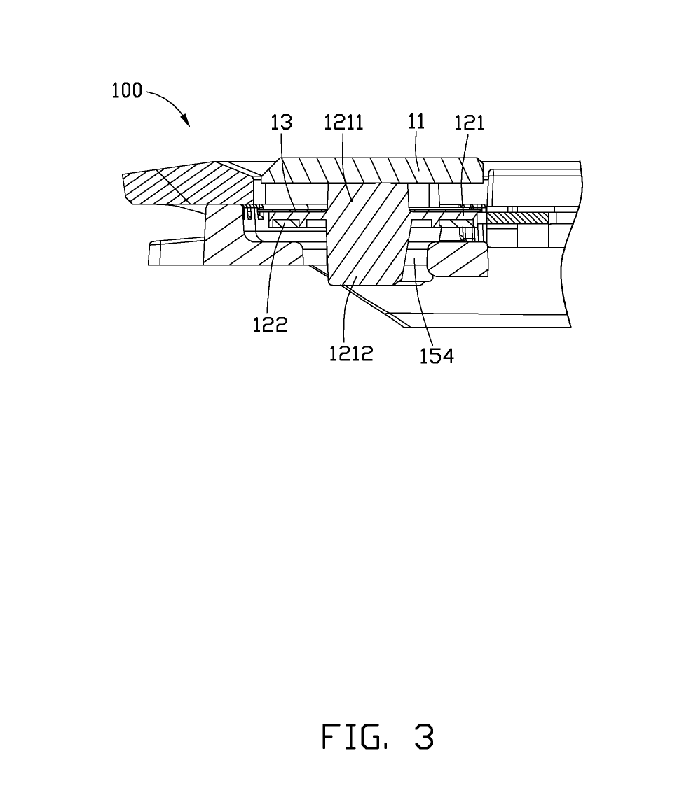

Also referring to FIG. 3, the key element 12 includes a main body 121 and a metallic sheet 122. The main body 121 may be made of thermoplastic polyurethanes. The main body 121 includes a number of contact portions 1211 and a number of elastic portions 1212, which respectively protrude from opposite sides of the main body 121. Each contact portion 1211 aligns with a corresponding elastic portion 1212. The contact portions 1211 respectively correspond to the indicating symbols. When the pressing element 11 is pressed, the pressure applied on the pressing element 11 is transmitted to the elastic portions 1212 by the contact portions 1211. The elastic portions 1212 produce an elastic deformation for pressing electrical contacts (not shown) formed on a circuit board (not shown) of the electronic devices to perform a desired operation. For example, when a user presses the connection symbol of the pressing element 11, the corresponded contact portion 1211 is pressed and makes the corresponding elastic portion 1212 have an elastic deformation. The deformed elastic portion 1212 then presses the corresponding electrical contact of the electronic device to perform a telephone connecting.

The main body 121 further defines a plurality of notches 1213 at one side of the main body 121. Each two notches 1213 is separated by a contact portion 1211. The metallic sheet 122 is integrally formed with the main body 121. The metallic sheet 122 enhances the strength of the main body 121.

The shielding element 13 is made of a resilient opaque material. The shielding element 13 is positioned between the key element 12 and the pressing element 11. The shielding element 13 defines a number of through holes 131 corresponding to the contact portions 1211 of the key element 12. The contact portions 1211 extend through the through holes 131 to latch the key element 12 on the shielding element 13. The shielding element 13 shields the light from a back-light (not shown) that may emit from the side of the key element 12 having the elastic portions 1212. The shielding element 13 further defines a number of cutouts 132 in one side of the shielding element 13, corresponding to the notches 1213.

The engaging element 14 has a “U” shaped frame structure. The engaging element 14 includes a first section 142 and two side sections 143 perpendicularly connecting with opposite ends of the first section 142. A number of latch portions 141 protrude from the first section 142 of the engaging element 14. The latch portions 141 mate with the notches 1213. When the contact portions 1211 are operated, the latch portions 141 move out of the notches 1213 or move in the notches 1213.

The base 15 may be one part of a housing of the electronic device (not shown). The base 15 includes two sidewalls 151 opposite to each other, and an end wall 152 connecting to the two sidewalls 151. A receiving space 153 is defined by the two sidewalls 151 and the end wall 152. The receiving space 153 can receive a display screen and circuit boards (not shown) of the electronic device. The end wall 152 has a limiting plate 154 towards the receiving space 153. The limiting plate 154 defines a number of limiting holes 1541. The elastic portions 1212 are received in the limiting holes 1541 for assembling the key element 12 on the base 15. The limiting plate 1541 can prevent the key element 12 from horizontally shake, allowing the elastic portions 1212 only to move along a vertical direction.

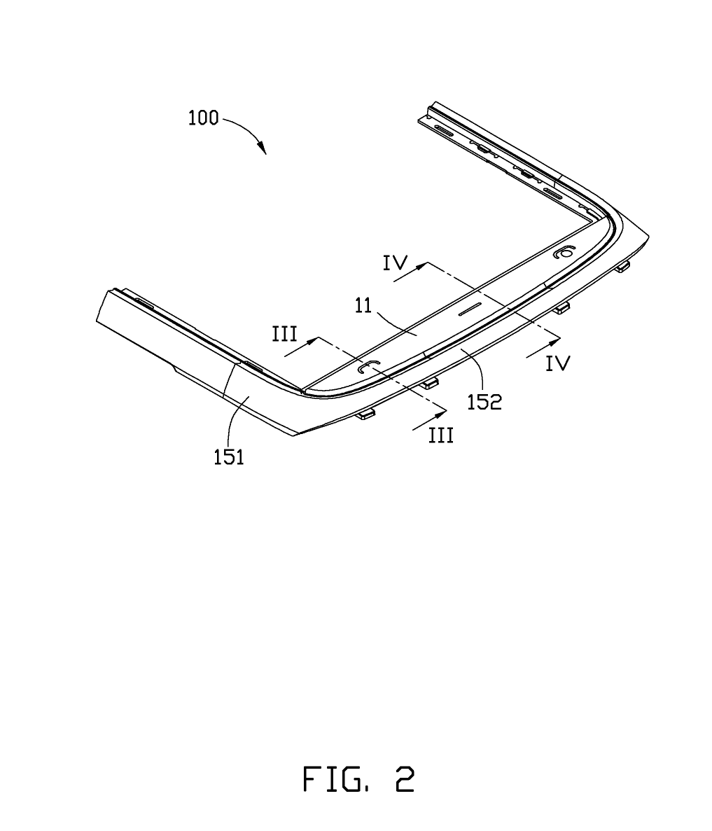

Also referring to FIG. 2, during assembly of the key assembly 100, the contact portions 1211 passes through the through holes 131 of the shielding element 13 to secure the shielding element 13 to the key element 12. The cutouts 132 align with the notches 1213 of the key element 12. Then, the latch portions 141 of the engaging element 14 are forced to slide into the notches 1213 of the key element 12 and the cutouts 132 of the shielding element 13, thus mounting the engaging element 14 to the key element 12. After that, the incorporated shielding element 13, the engaging element 14, and the key element 12 are mounted to the base 15. Specifically, the elastic portions 1212 respectively pass through and mate with the corresponding limiting holes 1541. Finally, the pressing element 11 is placed on the contact portions 1211 of the key element 12, and the pressing element 11 latches into the base 15. As such, the key assembly 100 is finished.

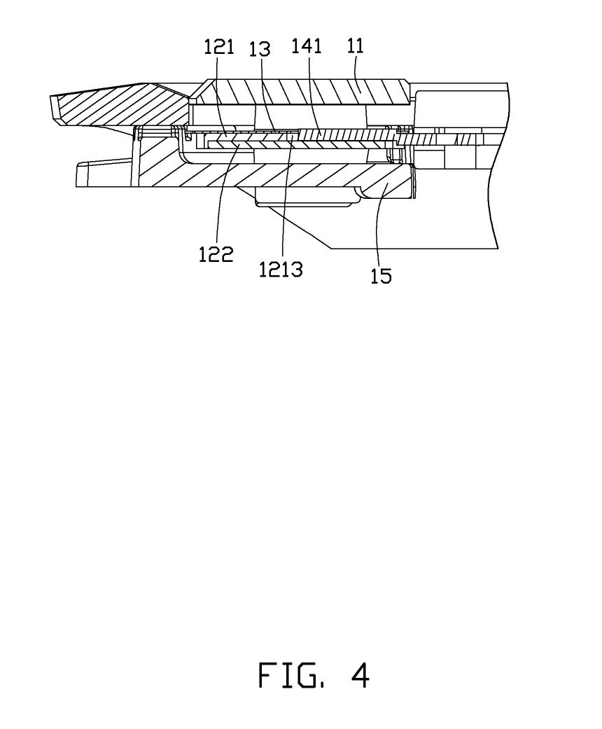

Referring to FIGS. 3 and 4, during using the key assembly 100, one of the indicating symbols of the pressing element 11 is pressed to force a corresponding elastic portion 1212 of the key element 12 to elastically deform. The elastic portion 1212 further contacts an electrical contact (not shown) of the electronic devices, thereby performing a corresponding function. The elastic portions 1212 move and deform only along a vertical direction, accordingly, the latch portions 141 can vertically move out of the notches 1213 during the pressing process. When the pressing element 11 at a pressed state is released, the elastic portions 1212 return back to an initial state, the latch portions 141 are received in the notches 1213 again. The engaging element 14 is positioned at one side of the key element 12 for preventing the key element 12 from moving along a horizontal direction. When the key element 12 is pressed along a vertical direction, the latch portions 141 of the engaging element 14 can move out of /in the notches 1213. Since the key element 12 freely moves along a vertical direction, and is not fixed by the engaging element 14, the key assembly 100 can provide a comfortable operation for users.

The metallic sheet 122 can be ground connected to shield the static electricity of the key assembly 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A key assembly, comprising:
a key element comprising a main body, the main body comprising a plurality of elastic portions and defining a plurality of notches on one side of the main body; and
an engaging element comprising a plurality of latch portions protruding from one side of the engaging element, the latch portions mating with the notches;
when the key element is operated, the elastic portion deforms to cause the latch portions moving out of or being received in the notches.

2. The key assembly as claimed in claim 1, further comprising a pressing element, wherein the main body further comprises a plurality of contact portions, when the pressing element is pressed, the pressure of the pressing element is transited to the elastic portion by the contact portion to force the elastic portion to elastically deform.

3. The key assembly as claimed in claim 2, wherein the contact portions and the elastic portions respectively protrude from opposite sides of the main body, each contact portion aligns with a corresponding elastic portion.

4. The key assembly as claimed in claim 2, wherein the assembly further comprising a shielding element positioned between the key element and the pressing element, the shielding element defines a plurality of through holes corresponding to the contact portions, the contact portions pass through the through holes.

5. The key assembly as claimed in claim 4, wherein the shielding element further defines a plurality of cutouts corresponding to the notches.

6. The key assembly as claimed in claim 1, wherein the assembly further comprises a base, the base comprises a limiting plate, the limiting plate defines a plurality of limiting holes corresponding to the elastic portions, the elastic portions pass through the limiting holes and mate with the limiting holes to locate the key element and prevent the key element from horizontally shake.

7. The key assembly as claimed in claim 6, wherein the base further comprises two sidewalls and an end wall connecting to the two sidewalls, a receiving space is defined by the two sidewalls and the end wall, the limiting plate is protruded from the end wall and towards the receiving space.

8. The key assembly as claimed in claim 1, wherein the key element further comprises a metallic sheet, the metallic sheet is integrally formed with the main body.

9. The key assembly as claimed in claim 1, wherein the main body is made of thermoplastic polyurethanes.

10. The key assembly as claimed in claim 4, wherein the shielding element is made of resilient opaque material.

11. The key assembly as claimed in claim 8, wherein the metallic sheet is ground connected to shield static electricity of the key assembly.
